(19) United States
(12) Patent Application Publication
(10) Pub. No.: US 2026/0354419 A1
(43) Pub. Date: Nov. 12, 2026

(54) METHOD OF MANUFACTURING PELLET TYPE FEED

(71) Applicant: EOharmony Inc., Sejong-si (KR)

(72) Inventor: ISU SHIN, Sejong-si (KR)

(21) Appl. No.: 19/383,907

(22) Filed: Nov. 10, 2025

(30) Foreign Application Priority Data
May 7, 2025 (KR) 10-2025-0059416

(51) Int. Cl. A23K 40/25; A23K 10/20

(52) U.S. Cl. CPC A23K 40/25; A23K 10/20

(57) ABSTRACT

A method for manufacturing a pellet feed includes opening a steam valve to supply steam to an extruder, checking a constant tank gauge to set constant conditions to the extruder, setting an extruder operating condition, supplying powdered raw material to a hopper, and forming pellet feed in a forming die installed at both ends of the extruder.

### CROSS REFERENCE TO RELATED APPLICATIONS AND CLAIM OF PRIORITY

This application claims the benefit under 35 USC § 119 of Korean Patent Application No. 10-2025-0059416, filed on May 7, 2025, in the Korean Intellectual Property Office, the entire disclosure of which is incorporated herein by reference for all purposes.

### BACKGROUND

### 1. Technical Field

The present invention relates to a method for manufacturing pellet feed.

### 2. Background Art

Human society continuously pursues happiness through emotional bonds with companion animals. Representative examples include dogs, cats, birds, and fish, which foster emotional connection.

Recently, as the trend of raising various types of companion animals, beyond dogs, cats, birds, and fish, has expanded, the number of households raising reptiles such as turtles and lizards, and amphibians such as frogs, has rapidly increased.

While mammals like dogs and cats require emotional connection through walks and playtime, most reptiles are not easily lonely, making them relatively easy to raise as long as the appropriate environment (e.g., temperature, humidity, and lighting) is in place.

According to statistics, the number of households owning companion animals reach 6.02 million in 2022, with 7.99 million pets. The domestic market itself is projected to grow at an average annual rate of 9.5%, from $6.2 billion in 2022 to $15.2 billion in 2032.

As the market for existing companion animals has expanded, a variety of feeds and snacks that satisfy both taste and nutrition have been developed and are readily available. However, while reptiles are becoming increasingly popular, readily available feeds and snacks are still difficult to find locally.

Therefore, households owning companion animals, such as reptiles, typically purchase them online or through recommendations from others. Information sharing on various foods occurs in a relatively limited environment.

This disclosure describes a method for manufacturing feeds that satisfy both taste and nutrition for various reptile companion animals in this environment.

Prior arts disclosed methods for manufacturing pellet feed using dried crickets. However, research and product development are needed for feed that facilitates the intake of essential nutrients for reptiles and amphibians.

Therefore, the present disclosure discloses a method for manufacturing a safe, natural feed that contains customized nutrients required by reptiles and amphibians.

### SUMMARY

The present invention is intended to solve the problems of the above-mentioned prior art, and can manufacture and produce customized nutrients required by reptiles and safe natural feed.

One embodiment of the present invention relates to a method for manufacturing pellet feed, including: a step of opening a steam valve to supply steam to an extruder; a step of checking a constant water tank gauge to set constant water conditions to the extruder; a step of setting extruder operating conditions; a step of supplying powdered raw material to a hopper; and a step of forming pellet feed in a forming die installed at both ends of the extruder.

In addition, the step of setting the constant water condition to the extruder is characterized by inputting the water on the constant water tank gauge to a state of 22% to 24%.

In addition, the extruder operating conditions are characterized by a temperature of 80 °C to 120 °C.

In addition, the pellet feed is characterized by using crickets as a raw material.

In addition, the pellet feed is characterized by using Ptecticus tenebrifer as a raw material.

The present invention is intended to solve the problems of the above-mentioned prior art, and can manufacture and produce customized nutrients and natural, safe feed required by reptiles and amphibians.

### BRIEF DESCRIPTION OF THE DRAWINGS

FIG. 1 is a conceptual diagram illustrating a pellet feed manufacturing system according to an example of the present invention.

FIG. 2 is a flowchart illustrating a pellet feed manufacturing process according to an example of the present invention.

FIG. 3 is a diagram illustrating pellets manufactured according to an example of the present invention.

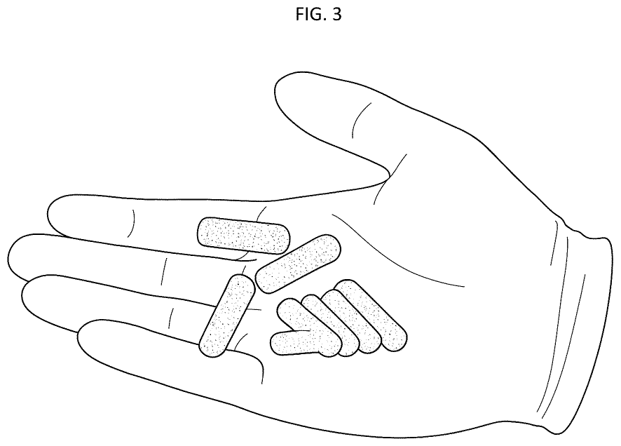

### DETAILED DESCRIPTION

Below, with reference to the attached drawings, embodiments of the present invention will be described in detail so that those skilled in the art can easily practice the invention. However, the present invention may be implemented in various different forms and is not limited to the embodiments described herein. Furthermore, for the purpose of clearly explaining the present invention, parts irrelevant to the description have been omitted in the drawings, and similar parts have been designated with similar reference numerals throughout the specification.

Throughout the specification, when a part is said to be “connected” to another part, this includes not only “directly connected” but also “electrically connected” with another element intervening between them. Furthermore, when a part is said to “include” a component, this does not exclude other components, but rather includes other components, unless otherwise specified.

In the present invention, “pellet” refers to feed or a product formed by compressing using a mold, also called “pellet.”

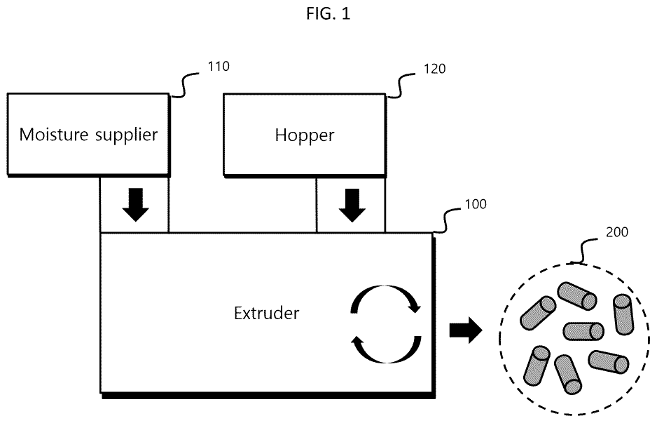

FIG. 1 is a conceptual drawing of a pellet feed manufacturing system according to an example of the present invention.

As shown in FIG. 1, the extruder (100) receives moisture from a moisture supplier (110) and powdered raw materials are fed through a hopper (120).

The extruder extrudes pellet feed (200) under high temperature and high pressure conditions inside to manufacture pellet feed.

The pellet feed according to one embodiment of the present invention is an extrusion feed and is manufactured using an extruder.

An extruder according to one embodiment of the present invention generally refers to a machine that processes feed or food by extruding it, and is classified into a dry extruder and a wet extruder depending on the processing method, and is classified into a single screw extruder and a dual screw extruder depending on the number of screws.

An extruder according to one embodiment of the present invention is a device that processes and shapes powder raw materials by feeding them into an extruder under high temperature and high pressure conditions through a screw, and can use the various types of shapes described above.

In the case of general dry feed, it is manufactured by extrusion method to form pellets, improve digestibility, and ensure product safety, and this process requires heat energy and mechanical energy.

The main source of thermal energy is steam, and mechanical energy refers to the energy that pushes through the extruder screw.

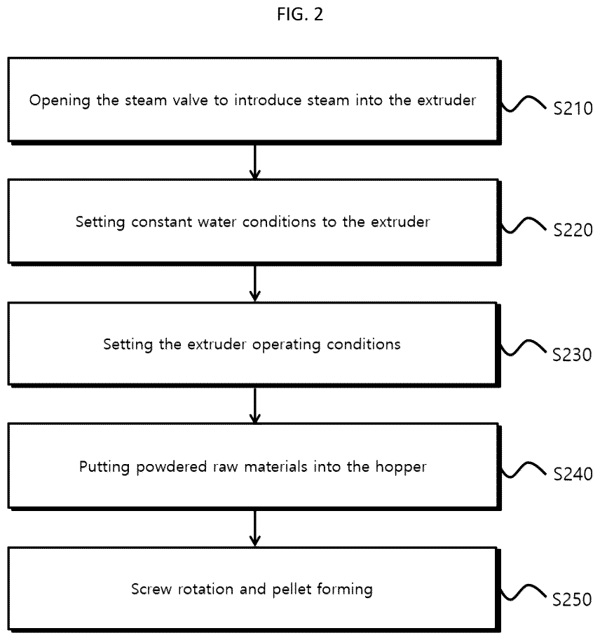

FIG. 2 is a flow chart showing a pellet feed manufacturing process according to an example of the present invention.

Even if the temperature is controlled inside the manufacturing facility to form a pellet according to one embodiment of the present invention, if moisture is retained, the temperature may drop and the heat energy transferred to the extruder may decrease rapidly. In this case, a problem may occur in forming the product. To prevent this, steam is used to supplement the heat energy lost due to the decrease in the ambient temperature.

Therefore, in order to manufacture pellets according to one embodiment of the present invention, the steam valve is opened to supply steam to the extruder (S210).

Afterwards, check the constant water tank gauge and set the extruder so that the water content is 22% to 24%.

Since a certain amount of moisture must be added to produce homogeneous pellets, determining the moisture conditions is very significant, and in particular, the moisture conditions must be determined according to the type of powdered raw material.

In the case where the moisture content of pellet feed according to one embodiment of the present invention is low, the strength of the feed increases and it becomes hard even when soaked in water (this may vary depending on the type of binder), but it has the advantage and disadvantage of being able to be stored for a long period of time. On the other hand, in the case where the moisture content is high, it has the opposite advantages and disadvantages.

In the case of an extruder according to one embodiment of the present invention, various temperature and pressure operating conditions for forming pellets can be set (S230), and various types of pellets can be produced according to the set conditions.

An extruder according to an example of the present invention can produce pelletized feed by extruding under extrusion conditions including an amount of water added, a main motor connected to a shaft inside a barrel and capable of controlling the rotation speed of the shaft, a feed motor capable of supplying powdered raw materials, and temperature control of a barrel portion.

An extruder according to an example of the present invention can adjust the amount of water added per minute so that the previously set moisture content is 22% to 24% (e.g., 70 ml/min), the main motor speed of the extruder can be set to 200 to 400 rpm, the feed motor speed to 200 to 250 rpm, the temperature in front of the barrel (the direction in which pellet feed comes out) to 80 to 90 °C, the temperature in the middle of the barrel to 100 to 120 °C, and the temperature at the back of the barrel to 80 to 90 °C.

That is, the extruder according to an example of the present invention can be operated in a temperature range of at least 80 °C and at most 120 °C, thereby operating under temperature conditions optimized for pellet production.

Once the extruder operating conditions are set, powder raw material is fed into the hopper (S240).

The powder raw material according to one embodiment of the present invention may include various ingredients, and different powder raw materials may be used depending on each type of reptile.

According to an example of the present invention, the powdered raw material is of a human grade that can be eaten by humans, and is a diet that takes the safety of reptiles into consideration, using natural ingredients and edible insects, optimizing the ratio of calcium and phosphorus, and does not contain chemical seasonings.

More specifically, as a material that can be consumed by the New Caledonian lizard species among reptiles, it can have the mixing ratios shown in Tables 1 and 2 below. The mixing ratios shown in Tables 1 and 2 below may include an error of ±10%.

TABLE 1

| Crude | Crude | Crude | Crude | | | |
|---|---|---|---|---|---|---|
| Protein | Fat | Fiber | Ash | Water | Calcium | Phosphorus |
| 23.0% | 5.0% | 3.9% | 5.6% | 9.0% | 1.16% | 0.51% |

TABLE 2

| Crude | Crude | Crude | Crude | | | |
|---|---|---|---|---|---|---|
| Protein | Fat | Fiber | Ash | Water | Calcium | Phosphorus |
| 20.0% | 5.0% | 1.7% | 5.4% | 10.1% | 1.06% | 0.46% |

In the case of the pellet feed in Tables 1 and 2 above, it should be noted that the diet is not suitable for leopard geckos as it is a diet tailored to lizards such as Skins, New Caledonia species, and Lychienus.

In addition, the powder raw material ingredients of the above pellets may optionally include banana, isolated whey protein, flaxseed powder, bee pollen, vitamin C, lecithin, coconut, oat dietary fiber, MSM (Methyl Sulfonyl methane), dibasic potassium phosphate, ferrous fumarate, vitamin E, nicotinamide, zinc oxide, vitamin A, pantothenic acid, vitamin D3, vitamin B6, hydrochloride, vitamin B12, vitamin B1, vitamin B2, folic acid, biotin, calcium carbonate, and xanthan gum.

In addition, the pellet feed according to one embodiment of the present invention may be made of crickets as a raw material, and more specifically, may be made of two spotted crickets (Gryllus bimaculatus) as a raw material.

Unlike the ingredients mentioned above, the mixing ratio shown in Table 3 below can be used as feed ingredients that can be consumed by all lizards, including leopard geckos. The mixing ratio in Table 3 below may include a ±10% error.

TABLE 3

| Crude | Crude | Crude | Crude | | | |
|---|---|---|---|---|---|---|
| Protein | Fat | Fiber | Ash | Water | Calcium | Phosphorus |
| 42.1% | 15.3% | 3.6% | 6.0% | 4.5% | 2.0% | 0.8% |

In the case of pellet feed that can be consumed by all lizard species as shown in Table 3 above, black soldier fly (Ptecticus tenebrifer) and two spotted crickets can be used as raw materials. In addition, the powdered raw materials of the above pellets can optionally include pea protein, soybean meal, wheat flour, brewer's yeast, tapioca, isolated whey protein, calcium carbonate, vitamin C2, lecithin, dibasic potassium phosphate, ferrous fumarate, vitamin E, nicotinamide, zinc oxide, vitamin A, pantothenic acid, vitamin D3, vitamin B6, hydrochloride, vitamin B12, vitamin B1, vitamin B2, folic acid, biotin, and potassium sorbate.

In the case of pellet feed according to an example of the present invention, since the nutrients for crickets and Ptecticus tenebrifer are included as they are, it has the advantageous effect of including all the essential nutrients required for reptiles.

In addition, the pellet feed according to one example of the present invention does not contain fish meal, has high palatability, and can be manufactured so that one pellet contains only essential nutrients and contains nutrients equivalent to one cricket.

A pellet feed manufacturing extruder according to an example of the present invention produces pellets by rotating a screw and forming pellets through mechanical energy (S250).

The size of the pellets can be shaped to a size that reptiles and amphibians can aggressively eat as they hunt, and pellet-type feed can provide a good texture to reptiles and amphibians if it is soaked in lukewarm water for more than 3 minutes before feeding.

For example, an extruder according to an example of the present invention can form pellets into pellets having a diameter of 3 to 15 mm and a length of 5 to 30 mm by setting the diameter of the die and the speed of the cutter.

In addition, the pellet feed according to an example of the present invention may be EP (Extruded Pellet) feed, which may be feed that is expanded and dried using a high temperature and high pressure extruder, and may have a texture and quality that are completely different from wet feed manufactured by mixing miscellaneous fish and powdered mixed feed, such as general MP (Moist Pellet) feed.

The foregoing description of the present invention is illustrative, and those skilled in the art will readily appreciate that modifications to other specific forms can be made without altering the technical spirit or essential characteristics of the present invention. Therefore, the embodiments described above should be understood as illustrative in all respects and not restrictive. For example, each component described as a single entity may be implemented in a distributed manner, and likewise, components described as distributed may be implemented in a combined manner.

The scope of the present invention is indicated by the claims described below rather than the detailed description above, and all changes or modifications derived from the meaning and scope of the claims and their equivalents should be construed as being included within the scope of the present invention.

What is claimed is:

1. A method for manufacturing a pellet feed, comprising:
opening a steam valve to supply steam to an extruder;
checking a constant tank gauge to set a constant condition for the extruder;
setting an extruder operating condition;
injecting powdered raw material into a hopper configured to supply the raw material to the extruder; and
forming pellet feed using forming dies installed at both ends of the extruder.

2. The method of claim 1, wherein the setting of the constant condition for the extruder comprises adding water at a level of 22% to 24% on the constant water tank gauge.

3. The method of claim 1, wherein the extruder operating condition comprises a temperature of 80 °C to 120 °C.

4. The method of claim 1, wherein the raw material comprises a cricket.

5. The method of claim 1, wherein the raw material comprises Ptecticus tenebrifer.
